(19) United States
(12) Patent Application Publication
(10) Pub. No.: US 2024/0221702 A1
(43) Pub. Date: Jul. 4, 2024

(54) VIDEO SIGNAL PROCESSING DEVICE, VIDEO SIGNAL PROCESSING METHOD, VIDEO SIGNAL OUTPUT DEVICE, AND MULTI-DISPLAY SYSTEM

(71) Applicant: SONY GROUP CORPORATION, TOKYO (JP)

(72) Inventors: KAZUO YAMAMOTO, TOKYO (JP); NAOKO NAKAMURA, TOKYO (JP)

(21) Appl. No.: 18/557,503

(22) PCT Filed: Feb. 8, 2022
(86) PCT No.: PCT/JP2022/004820

§ 371 Date: Oct. 26, 2023

(30) Foreign Application Priority Data
May 20, 2021 (JP) 2021-085026

(51) Int. Cl. G09G 5/00

(52) U.S. Cl. CPC G09G 5/006; G09G 2370/042

(57) ABSTRACT

An appropriate video stream corresponding to a type of multi-display display is supplied to each of a plurality of display devices. Capability information is received from each of a plurality of display devices. Multi-stream information is generated on the basis of the capability information of the plurality of display devices and information of a type of multi-display display implemented by the plurality of display devices, and is transmitted to a video signal output device. A multi-stream including video streams for the plurality of display devices, respectively, generated on the basis of the multi-stream information is received from the video signal output device. A plurality of video streams is extracted from the multi-stream to be transmitted to a corresponding display device out of the plurality of display devices.

### TECHNICAL FIELD

The present technology relates to a video signal processing device, a video signal processing method, a video signal output device, and a multi-display system, and more particularly relates to a video signal processing device that extracts a plurality of video streams from a multi-stream and transmits each of them to a corresponding display device and the like.

### BACKGROUND ART

Conventionally, it is known to perform multi-display display using a plurality of display devices. Furthermore, Patent Document 1 discloses a control method when performing multi-display display using a multi-stream transmission function of DisplayPort. In this case, a multi-stream signal transmitted from a source device within a range of definition prescribed in DisplayPort is processed on a sink device side using information such as resolution to implement the multi-display display. That is, the sink device processes a signal of resolution that can be reproduced by the sink device in the transmitted multi-stream so as to display the signal, and outputs a signal, which is not compatible, as-is to another device connected next to the sink device.

### CITATION LIST

### Patent Document

Patent Document 1: Japanese Patent Application Laid-Open No. 2015-055845

### SUMMARY OF THE INVENTION

### Problems to be Solved by the Invention

An object of the present technology is to be able to supply an appropriate video stream corresponding to a type of multi-display display to each of a plurality of display devices.

### Solutions to Problems

A concept of the present technology is
a video signal processing device including:
an information reception unit that receives capability information from each of a plurality of display devices;
an information transmission unit that generates multi-stream information on the basis of the capability information of the plurality of display devices and information of a type of multi-display display implemented by the plurality of display devices, and transmits the multi-stream information to a video signal output device;
a multi-stream reception unit that receives, from the video signal output device, a multi-stream including video streams for the plurality of display devices, respectively, generated on the basis of the multi-stream information; and
a video stream transmission unit that extracts the plurality of video streams from the multi-stream and transmits each of the plurality of video streams to a corresponding display device out of the plurality of display devices.

In the present technology, the information reception unit receives the capability information from each of the plurality of display devices. Then, multi-stream information is generated on the basis of the capability information of the plurality of display devices and the information of the type of multi-display display implemented by the plurality of display devices, and is transmitted to the video signal output device by the information transmission unit. For example, the type of multi-display display may include at least any one of optional arrangement, preset arrangement, planar arrangement, circumferential surface arrangement, or spherical surface arrangement.

For example, the multi-stream information may include information of the number of the plurality of display devices and information of the type of multi-display display. Therefore, the video signal output device may appropriately generate the video streams for the plurality of display devices, respectively, depending on the type of multi-display display.

In this case, for example, the multi-stream information may include stream identification information and arrangement position information corresponding to each of the plurality of display devices. Therefore, the video signal output device can generate the video stream for each of the plurality of display devices depending on the arrangement position, and can appropriately include stream identification information indicating to which display device this corresponds in the video stream.

For example, in a case where the type of multi-display display is planar arrangement, the multi-stream information may include information of a pixel position on an upper left end of a screen corresponding to each of the plurality of display devices. Therefore, the video signal output device can appropriately generate the video streams for the plurality of display devices, respectively, in accordance with the arrangement positions of the plurality of display devices and resolution in a case where the type of multi-display display is the planar arrangement.

Furthermore, for example, in a case where the type of multi-display display is circumferential surface arrangement, the multi-stream information may include information of a screen center angle and information of an occupied viewing angle corresponding to each of the plurality of display devices. Therefore, the video signal output device can appropriately generate the video streams for the plurality of display devices, respectively, in accordance with the arrangement positions of the plurality of display devices in a case where the type of multi-display display is the circumferential surface arrangement.

Furthermore, for example, in a case where the type of multi-display display is spherical surface arrangement, the multi-stream information may include information of a screen horizontal direction center angle, information of a screen vertical direction center angle, and information of an occupied viewing angle in a horizontal direction or a vertical direction corresponding to each of the plurality of display devices. Therefore, the video signal output device can appropriately generate the video streams for the plurality of display devices, respectively, in accordance with the arrangement positions of the plurality of display devices in a case where the type of multi-display display is the spherical surface arrangement.

Furthermore, for example, the multi-stream information may include information of a video format corresponding to each of the plurality of display devices. Therefore, the video signal output device can generate the video streams for the plurality of display devices, respectively, at resolution and frame rate appropriate to each display device.

The multi-stream including the video streams for the plurality of display devices, respectively, generated on the basis of the multi-stream information is received by the multi-stream reception unit from the video signal output device. Then, the plurality of video streams is extracted from the multi-stream to be transmitted to the corresponding display device out of the plurality of display devices by the video stream transmission unit.

For example, each of the video streams included in the multi-stream may include stream identification information indicating the display device to which the video stream corresponds. Therefore, it is possible to easily know to which display device each video stream extracted from the multi-stream corresponds.

In this manner, in the present technology, the capability information is received from each of a plurality of display devices, the multi-stream information is generated on the basis of the capability information of the plurality of display devices and the information of the type of multi-display display implemented by the plurality of display devices to be transmitted to the video signal output device, the multi-stream including the video streams for the plurality of display devices, respectively, generated on the basis of the multi-stream information is received from the video signal output device, and the plurality of video streams is extracted from the multi-stream to be transmitted to the corresponding display device out of the plurality of display devices. Therefore, it becomes possible to supply an appropriate video stream corresponding to a type of multi-display display to each of a plurality of display devices.

Furthermore, another concept of the present technology is
a video signal processing method including steps of:
receiving capability information from each of a plurality of display devices;
generating multi-stream information on the basis of the capability information of the plurality of display devices and information of a type of multi-display display implemented by the plurality of display devices, and transmitting the multi-stream information to the video signal output device;
receiving, from the video signal output device, a multi-stream including video streams for the plurality of display devices, respectively, generated on the basis of the multi-stream information; and
extracting the plurality of video streams from the multi-stream and transmitting each of the plurality of video streams to a corresponding display device out of the plurality of display devices.

Furthermore, another concept of the present technology is
a video signal output device including:
an information reception unit that receives, from a video signal processing device to which a plurality of display devices is connected, multi-stream information generated on the basis of capability information of the plurality of display devices and information of a type of multi-display display implemented by the plurality of display devices; and
a multi-stream transmission unit that generates a multi-stream including video streams for the plurality of display devices, respectively, on the basis of the multi-stream information, and transmits the multi-stream to the video signal processing device.

Furthermore, another concept of the present technology is
a video signal output device including:
an information reception unit that receives capability information from each of a plurality of display devices; and
a video stream transmission unit that generates video streams for the plurality of display devices, respectively, on the basis of the capability information of the plurality of display devices and information of a type of multi-display display implemented by the plurality of display devices, and transmits each of the video streams to a corresponding display device out of the plurality of display devices.

Furthermore, another concept of the present technology is
a multi-display system including:
a video signal output device and a plurality of display devices connected to each other via a video signal processing device, in which
the video signal processing device:
receives capability information from each of the plurality of display devices;
generates multi-stream information on the basis of the capability information of the plurality of display devices and information of a type of multi-display display implemented by the plurality of display devices, and transmits the multi-stream information to the video signal output device;
receives, from the video signal output device, a multi-stream including video streams for the plurality of display devices, respectively, generated on the basis of the multi-stream information; and
extracts the plurality of video streams from the multi-stream and transmits each of the plurality of video streams to a corresponding display device out of the plurality of display devices.

### BRIEF DESCRIPTION OF DRAWINGS

FIG. 1 is a block diagram illustrating a configuration example of a multi-display system.

FIG. 2 is a diagram illustrating a configuration example of an HDMI system including a data transmission unit (HDMI transmission unit) of a source device and a data reception unit (HDMI reception unit) of a sink device.

FIG. 3 is a diagram illustrating an example of a link rate and the number of lanes corresponding to each link.

FIG. 4 is a diagram illustrating a structure example of an EDID extension block as a newly defined information block in a case of using EDID.

FIG. 5 is a diagram illustrating a structure example of a newly defined SCDCS information block in a case where SCDCS data is used.

FIG. 6 is a diagram illustrating a structure example of 10-byte information of “Monitor Location Info”.

FIG. 7 is a diagram illustrating an example of a correspondence relation between a value of “Type” and a type of multi-display display.

FIG. 8 is a diagram illustrating a structure example of information portions of “Type”, “ID”, and “Params” in 10-byte information of “Monitor Location Info” in a case where the type of multi-display display is optional arrangement.

FIG. 9 is a diagram illustrating a structure example of information portions of “Type”, “ID”, and “Params” in 10-byte information of “Monitor Location Info” in a case where the type of multi-display display is preset arrangement.

FIG. 10 is a diagram illustrating an example of a correspondence relation between a value of “Type” and a type of preset arrangement.

FIG. 11 is a diagram for explaining the type of preset arrangement.

FIG. 12 is a diagram for explaining the type of preset arrangement.

FIG. 13 is a diagram illustrating a structure example of information portions of “Type”, “ID”, and “Params” in 10-byte information of “Monitor Location Info” in a case where the type of multi-display display is planar arrangement.

FIG. 14 is a diagram illustrating a specific example of the planar arrangement.

FIG. 15 is a diagram illustrating information of an X position and a Y position when “ID” is 1 to 3.

FIG. 16 is a diagram illustrating a structure example of information portions of “Type”, “ID”, and “Params” in 10-byte information of “Monitor Location Info” in a case where the type of multi-display display is circumferential surface arrangement.

FIG. 17 is a diagram illustrating an arrangement configuration example of the display devices in a case where the type of multi-display display is the circumferential surface arrangement.

FIG. 18 is a diagram illustrating an arrangement configuration example of the display devices in a case where the type of multi-display display is the circumferential surface arrangement.

FIG. 19 is a diagram illustrating information of a screen center angle θ and an occupied viewing angle 40 when “ID” is 1 to 3.

FIG. 20 is a diagram illustrating a structure example of information portions of “Type”, “ID”, and “Params” in 10-byte information of “Monitor Location Info” in a case where the type of multi-display display is spherical surface arrangement.

FIG. 21 is a diagram conceptually illustrating a screen horizontal direction center angle θ, a screen vertical direction center angle φ, and a horizontal direction occupied viewing angle Δθ in a case where the display device is arranged on a spherical surface.

FIG. 22 is a diagram conceptually illustrating a screen horizontal direction center angle θ, a screen vertical direction center angle φ, and a horizontal direction occupied viewing angle Δθ in a case where the display device is arranged on a spherical surface.

FIG. 23 is a diagram illustrating a structure example of InfoFrame.

FIG. 24 is a diagram illustrating an operation sequence of the multi-display system.

FIG. 25 is a block diagram illustrating a configuration example of a video signal output device and a video signal processing device.

FIG. 26 is a block diagram illustrating a configuration example of a display device 200.

FIG. 27 is a diagram for explaining an example in which the type of multi-display display is the preset arrangement, and the type of preset arrangement is “four-divided screen” in which the four display devices are arranged in a square lattice pattern in a horizontal placement state.

FIG. 28 is a diagram for explaining “Monitor Location Info” information corresponding to each display device included in the multi-stream information generated by the video signal processing device.

FIG. 29 is a diagram illustrating a structure example of an EDID extension block including “Monitor Location Info” information corresponding to the four display devices 200.

FIG. 30 is a diagram illustrating a structure example of InfoFrame inserted into a video stream for a display device (sink 1) generated by the video signal output device.

FIG. 31 is a diagram illustrating a structure example of InfoFrame inserted into a video stream for a display device (sink 2) generated by the video signal output device.

FIG. 32 is a diagram illustrating a structure example of InfoFrame inserted into a video stream for a display device (sink 3) generated by the video signal output device.

FIG. 33 is a diagram illustrating a structure example of InfoFrame inserted into a video stream for a display device (sink 4) generated by the video signal output device.

FIG. 34 is a diagram illustrating an example of a use case in a case where processing of associating with a position where the display device is arranged is performed as audio processing in the video signal output device.

FIG. 35 is a diagram illustrating another example of a use case in a case where processing of associating with a position where the display device is arranged is performed as audio processing in the video signal output device.

### MODE FOR CARRYING OUT THE INVENTION

Hereinafter, an embodiment for implementing the invention (hereinafter, referred to as an “embodiment”) will be described. Note that, the description will be given in the following order.
1. Embodiment
2. Variation

### 1. Embodiment

### [Configuration Example of Multi-Display System]

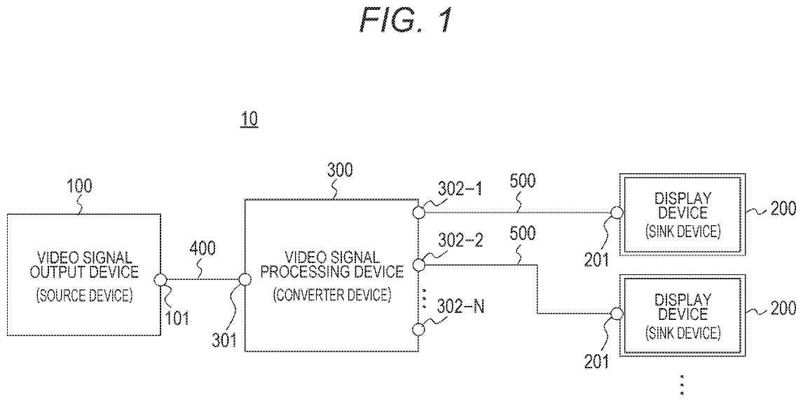

FIG. 1 illustrates a configuration example of a multi-display system 10. The multi-display system 10 includes a video signal output device (sink device) 100, a plurality of display devices (sink devices) 200, and a video signal processing device (converter device) 300 interposed between the video signal output device 100 and the sink device 200.

The video signal output device 100 and the video signal processing device 300 are connected to each other via a high-definition multimedia interface (HDMI) cable 400. Furthermore, the video signal processing device 300 and the plurality of display devices 200 are connected to each other via HDMI cables 500. Here, each of the HDMI cables 400 and 500 forms a transmission line. Note that, “HDMI” is a registered trademark.

The video signal output device 100 includes one HDMI output terminal (HDMI terminal) 101. Furthermore, the video signal processing device 300 includes one HDMI input terminal (HDMI terminal) 301 and a plurality of HDMI output terminals (HDMI terminals) 302-1 to 302-N. Furthermore, the display device 200 includes one HDMI input terminal (HDMI terminal) 201.

The HDMI output terminal 101 of the video signal output device 100 is connected to the HDMI input terminal 301 of the video signal processing device 300 via the HDMI cable 400. Furthermore, the HDMI input terminals 201 of the plurality of display devices 200, 200, . . . are connected to the plurality of HDMI output terminals 302-1, 302-2, . . . of the video signal processing device 300 via the HDMI cables 500, respectively.

### [Configuration Example of HDMI System]

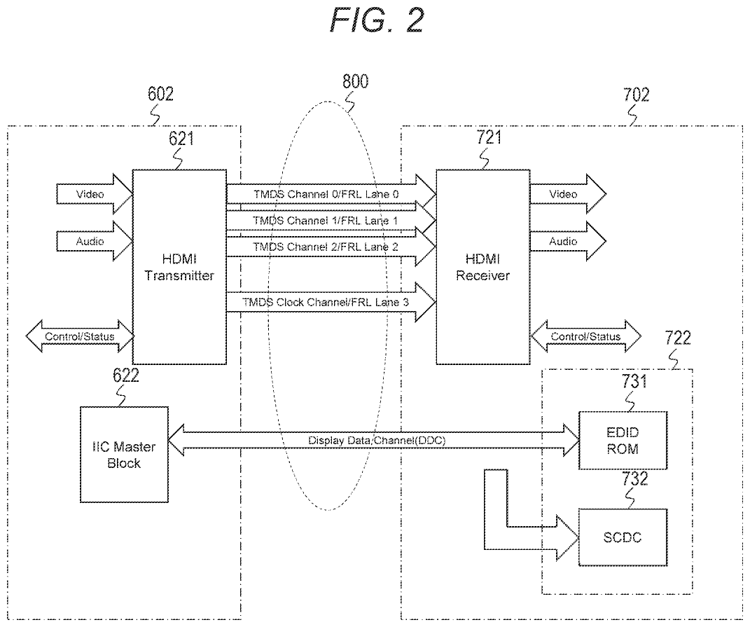

FIG. 2 illustrates a configuration example of an HDMI system including a data transmission unit (HDMI transmission unit) 602 of a source device and a data reception unit (HDMI reception unit) 702 of the sink device.

The data transmission unit 602 transmits differential signals corresponding to pixel data of an uncompressed image for one screen in one direction to the data reception unit 702 through a plurality of channels in an effective image period (hereinafter, also referred to as an active video period as appropriate) that is a period obtained by removing a horizontal retrace period and a vertical retrace period from a period from one vertical synchronization signal to a next vertical synchronization signal, and transmits differential signals corresponding to at least audio data, control data, other auxiliary data and the like accompanying the image in one direction to the data reception unit 702 through a plurality of channels in the horizontal retrace period or the vertical retrace period.

That is, the data transmission unit 602 includes an HDMI transmitter 621. The HDMI transmitter 621 converts the pixel data of the uncompressed image to the corresponding differential signals and serially transmits the same in one direction to the data reception unit 702 connected thereto via an HDMI cable 800 through three TMDS channels #0, #1, and #2 being a plurality of channels, for example.

Furthermore, the HDMI transmitter 621 converts the audio data, furthermore, required control data, other auxiliary data and the like accompanying the uncompressed image into the corresponding differential signals, and serially transmits the same in one direction to the data reception unit 702 connected thereto via the HDMI cable 800 through the three TMDS channels #0, #1, and #2.

Moreover, the HDMI transmitter 621 transmits a pixel clock synchronized with the pixel data transmitted through the three TMDS channels #0, #1, and #2 to the data reception unit 702 connected thereto via the HDMI cable 800 through a TMDS clock channel. Here, 10-bit pixel data is transmitted in one pixel clock through one TMDS channel #i (i=0, 1, 2).

Here, TMDS coding is 8-bit/10-bit conversion coding for converting 8-bit data into 10-bit data, and is coding for maintaining DC balance while suppressing adverse effects such as unnecessary radiation by reducing the number of transition points from comparison with previous data. Therefore, since run-length of coding cannot be theoretically guaranteed, DC coupling and separate transmission of a clock are essential.

The data reception unit 702 receives the differential signals corresponding to the pixel data transmitted in one direction from the data transmission unit 602 through the plurality of channels in the active video period, and receives the differential signals corresponding to the audio data and the control data transmitted in one direction from the data transmission unit 602 through the plurality of channels in the horizontal retrace period or the vertical retrace period.

That is, the data reception unit 702 includes an HDMI receiver 721. The HDMI receiver 721 receives the differential signals corresponding to the pixel data and the differential signals corresponding to the audio data and the control data transmitted in one direction from the data transmission unit 602 connected thereto via the HDMI cable 800 through the TMDS channels #0, #1, and #2 in synchronization with the pixel clock similarly transmitted from the data transmission unit 602 through the TMDS clock channel.

Note that, in the above description, an example is described in which the image data, the audio data, and the control data are transmitted through the TMDS channels #0, #1, and #2, and the pixel clock is transmitted through the TMDS clock channel, and this is compatible with HDMI 1.4 and before and HDMI 2.0. In a case of HDMI 2.1, transmission using FRL lanes #0, #1, #2, and #3 is performed. In this case, the TMDS clock channel in FIG. 2 serves as the FRL lane #3.

In this case, data transmission by a fixed rate link (FRL) packet using three lanes of #0 to #2 or four lanes of #0 to #3 is performed. Here, FRL character coding is 16-bit/18-bit conversion coding for converting 16-bit data into 18-bit data, is coding for maintaining the DC balance, and is coding capable of performing clock extraction.

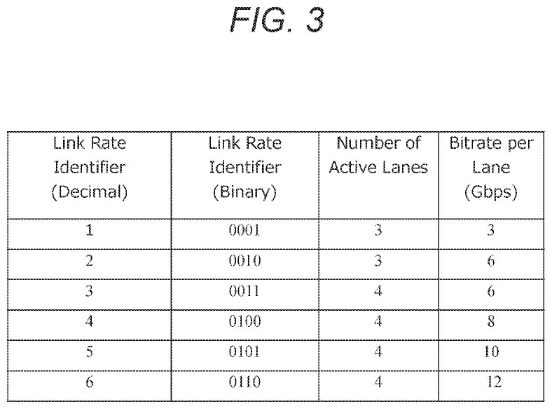

FIG. 3 illustrates an example of a link rate and the number of lanes corresponding to each link. At the link rates identified by “1” (binary 0001) and “2” (binary 0010), three lanes of #0 to #2 out of four lanes of #0 to #3 are used. In this case, the lane #3 is an inactive lane. Note that, the active lane means a lane for transmitting data. Furthermore, at the link rates identified by “3” (binary 0011), “4” (binary 0100), “5” (binary 0101), and “6” (binary 0110), all the four lanes of #0 to #3 are used.

In the illustrated example, at the link rate identified by “1” (binary 0001), the bit rate per lane is 3 Gbps. Furthermore, at the link rates identified by “2” (binary 0010) and “3” (binary 0011), the bit rate per lane is 6 Gbps. Furthermore, at the link rate identified by “4” (binary 0100), the bit rate per lane is 8 Gbps. Furthermore, at the link rate identified by “5” (binary 0101), the bit rate per lane is 10 Gbps. Moreover, at the link rate identified by “6” (binary 0110), the bit rate per lane is 12 Gbps.

Referring back to FIG. 2, as a transmission channel of the HDMI system including the data transmission unit 602 of the source device and the data reception unit 702 of the sink device, there also is a transmission channel referred to as a display data channel (DDC). The DDC includes two signal lines not illustrated included in the HDMI cable 800, and performs inter-integrated circuit (IIC) communication between the data transmission unit 602 and the data reception unit 702.

That is, the data transmission unit 602 includes an IIC master block 622. Furthermore, the data reception unit 702 includes a memory unit 722. The memory unit 722 includes an extended display identification data ROM (EDID ROM) 731, a status and control data channel (SCDC) register unit 732 and the like.

In the EDID ROM 731, EDID, which is information regarding a configuration and a possible function (configuration/capability) of the sink device is set, and this is read by the IIC master block 622 to the source device side through the DDC. Therefore, the source device recognizes the configuration and the possible function (capability) of the sink device. Note that, the EDID ROM 731 is implemented by, for example, a rewritable memory such as an electrically erasable programmable read-only memory (EEPROM) or a flash memory, but may be implemented by a random access memory (RAM) or any other storage medium. Furthermore, the above-described EDID is also referred to as an enhanced-EDID (E-EDID).

A status and control data channel (SCDC) corresponds to a point to point communication protocol in which the source device and the sink device exchange data. Note that, this SCDC is defined in HDMI 2.0 and thereafter. The SCDC register unit 732 includes a register group that stores an SCDC structure (SCDCS).

The source device (data transmission unit 602) can read and write data of the SCDCS stored in the SCDC register unit 732 by the IIC master block 622 through the DDC. The data of the SCDCS includes data regarding a current link state, data for controlling an operation of the source device and the like.

Furthermore, although not illustrated, in the HDMI cable 800, a consumer electronics control (CEC) line, a hot plug detect (HPD) line, a reserve line, a power source line and the like are included. The CEC line is used to perform bidirectional communication of data for control between the source device and the sink device. The HPD line is used for the source device to detect connection of the sink device and the like.

Referring back to FIG. 1, the plurality of display devices 200 connected to the video processing device 300 forms multi-display. In this case, the number of display devices 200 and an arrangement state thereof correspond to a type of multi-display display. Types of multi-display display include optional arrangement, preset arrangement, planar arrangement, circumferential surface arrangement, spherical surface arrangement and the like.

Here, the optional arrangement means a case where respective screens of the plurality of display devices 200 are independent from each other and have no relationship. Furthermore, the preset arrangement means a case where the arrangement of the screens formed by the plurality of display devices 200 is the screen arrangement set in advance. Furthermore, the planar arrangement means a case where components such as a size of each screen can be freely set in a case where one flat screen is created by combining the screens formed by the plurality of display devices 200. Furthermore, the circumferential surface arrangement means a case where the plurality of display devices 200 is arranged on a circumferential surface to create a panoramic screen. Furthermore, the spherical surface arrangement means a case where the plurality of display devices 200 is arranged on a spherical surface to create a celestial screen.

Furthermore, the video signal processing device 300 receives capability information from each of the plurality of display devices 200. This capability information is transmitted from the display device 200 to the video signal processing device 300 using the EDID. The capability information also includes information such as resolution and a frame rate.

Then, the video signal processing device 300 generates multi-stream information on the basis of the capability information transmitted from the plurality of display devices 200 and information of the type of multi-display display implemented by the plurality of display devices 200, and transmits the same to the video signal output device 100. The multi-stream information includes the information of the type of multi-display display, and, corresponding to each of the plurality of display devices 200, information of the HDMI output terminal of the video signal processing device 300 to which the display device 200 is connected, information of the arrangement position in the multi-display display of the display device 200, generation information of the video stream for the display device 200 and the like.

Here, the type of multi-display display is set by a user operation, for example. In this case, the user arranges the required number of display devices 200 at predetermined positions depending on the type of multi-display display to be implemented, connects each of them to the video signal processing device 300, and further sets the type of multi-display display in the video signal processing device 300. Note that, in a case where the video signal processing device 300 corresponds to a specific type of multi-display display, the type of multi-display display is uniquely determined.

Note that, the video signal processing device 300 has information of a correspondence relation between the HDMI output terminals to which the plurality of display devices 200 is connected, respectively, and the arrangement positions in the multi-display display of the display devices 200 connected to the HDMI output terminals, respectively. This correspondence relation is required, when the video stream is transmitted from the video signal processing device 300 to each of the plurality of display devices 200, for correctly transmitting to each of the display devices 200 the video stream corresponding to the arrangement position in the multi-display display of the display device 200. Although detailed description is omitted, the setting of the correspondence relation is set by, for example, the user operation or another method.

The video signal processing device 300 transmits the multi-stream information to the video signal output device 100 using the EDID or SCDCS data.

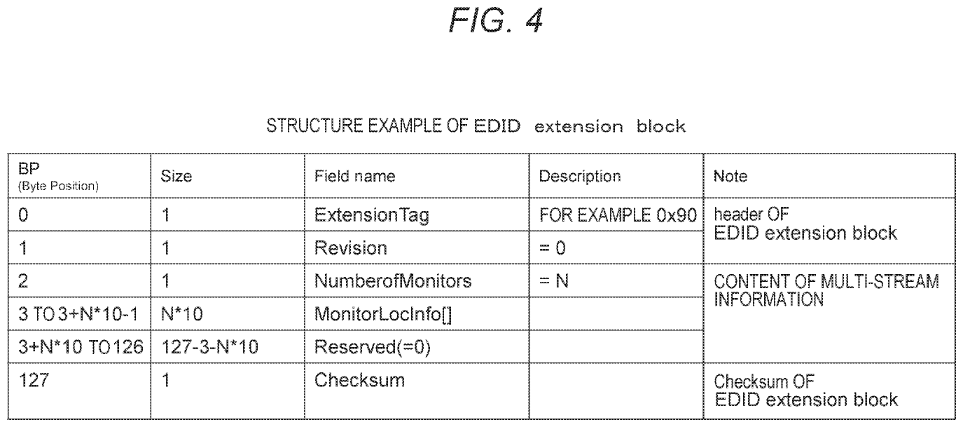

FIG. 4 illustrates a structure example of an EDID extension block as a newly defined information block in a case of using the EDID. A zeroth byte (BP0) and a first byte form a header. In a second byte, a 1-byte information of “NumberofMonitors” is arranged. This information indicates the number N of the display devices 200 forming the multi-display.

N*10-byte information of “MonitorLocInfo [ ]” is arranged in third to (3+N*10−1)-th bytes. Then, in the information of “MonitorLocInfo [ ]”, 10-byte information of “Monitor Location Info” is arranged corresponding to each of the N display devices 200. The information of “Monitor Location Info” includes information of a video format, information of the type of multi-display display, information of the arrangement position in the multi-display display, information of the connected HDMI output terminal, information for generating the video stream and the like.

“Reserved (=0)” is set in (3+N*10)-th to 126-th bytes. Furthermore, 1-byte information of “Checksum” is arranged in a 127-th byte.

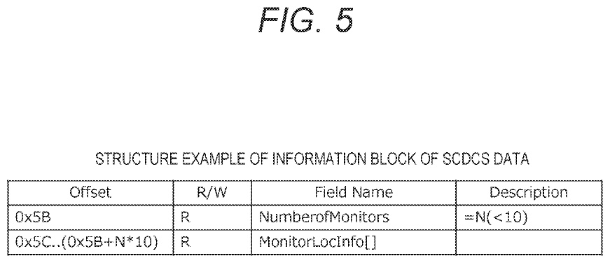

FIG. 5 illustrates a structure example of a newly defined SCDCS information block in a case where the SCDCS data is used. In offset 0x5B byte, 1-byte information of “NumberofMonitors” is arranged. Furthermore, N*10-byte information of “MonitorLocInfo [ ]” is arranged in offset 0x5C to (0x5B+N*10) bytes.

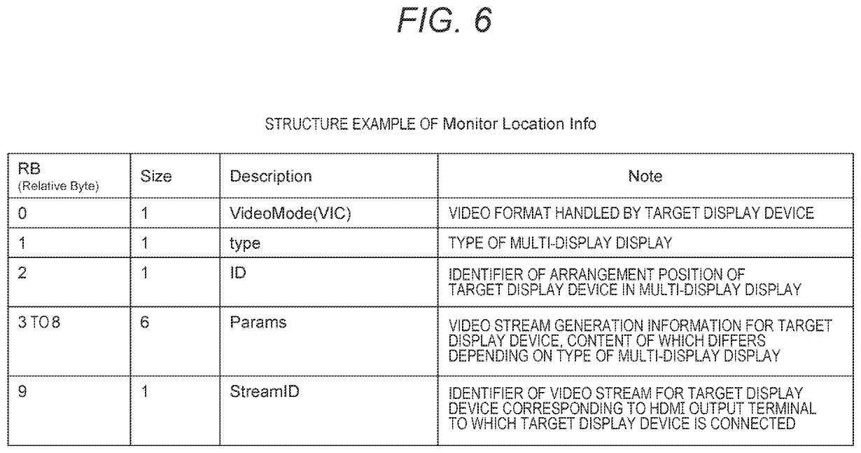

FIG. 6 illustrates a structure example of 10-byte information of “Monitor Location Info”. In a zeroth byte, 1-byte information of “VideoMode (VIC)” is arranged. This information is, for example, a video identification code (VIC), and indicates the video format such as the resolution and frame rate handled by a target display device 200. When generating the video stream for the target display device 200, the video signal output device 100 specifies the format of the video stream on the basis of this information.

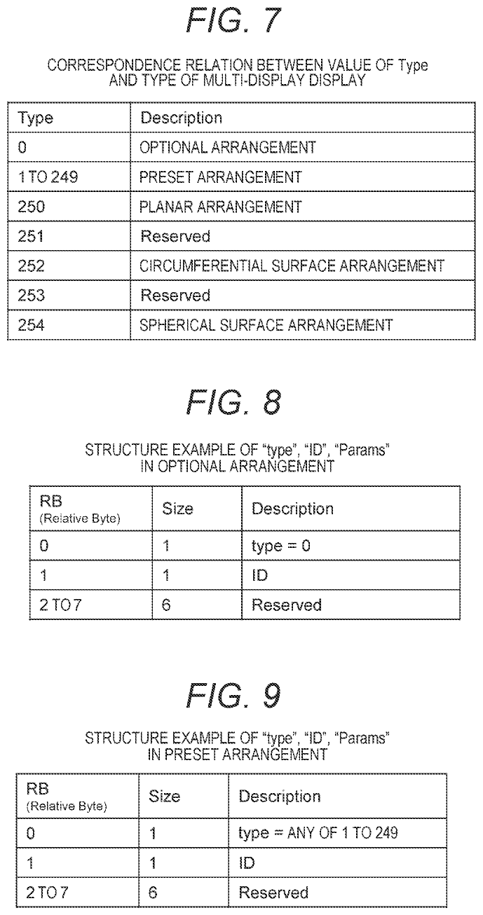

Information of “Type” is arranged in a first byte. This information indicates the type of multi-display display. FIG. 7 illustrates an example of a correspondence relation between a value of “Type” and the type of multi-display display.

It is indicated by “0” that the type of multi-display display is the optional arrangement. Furthermore, “1 to 249” indicates that the type of multi-display display is the preset arrangement. In this case, the value of “Type” varies depending on the type of preset arrangement.

Furthermore, “250” indicates that the type of multi-display display is the planar arrangement. Furthermore, “252” indicates that the type of multi-display display is the circumferential surface arrangement. Furthermore, “254” indicates that the type of multi-display display is the spherical surface arrangement.

Referring back to FIG. 6, information of “ID” is arranged in a second byte. This information indicates an identifier of the arrangement position in the multi-display display of the target display device 200. Note that, in each type of multi-display display, a correspondence relation between the arrangement positions of the plurality of display devices 200 in the multi-display display and the identifiers thereof is set in advance.

Information of “Params” is arranged in third to eighth bytes. This information indicates information for generating the video stream for the target display device 200, and differs depending on the value of “Type”, that is, the type of multi-display display.

Information of “StreamID” is arranged in a ninth byte. This information corresponds to the HDMI output terminal of the video signal processing device 300 to which the target display device 200 is connected, and indicates the identifier of the video stream for the target display device 200.

Details of 10-byte information of “Monitor Location Info” for each type of multi-display display will be described. Initially, a case where the type of multi-display display is the optional arrangement is described. The optional arrangement means a case where the respective screens of the plurality of display devices 200 are independent from each other and have no relationship as described above.

For example, a case where videos of different applications are displayed, a case where videos of different contents are displayed, a case where videos of different channels are displayed on the respective screens of the plurality of display devices 200 or the like are conceivable. Note that, even in a case where different videos are displayed on the respective screens of the plurality of display devices 200, a case where it is desired to specify a display position of each video corresponds to the preset arrangement.

FIG. 8 illustrates a structure example of information portions of “Type”, “ID”, and “Params” in 10-byte information of “Monitor Location Info” (refer to FIG. 6) in a case where the type of multi-display display is the optional arrangement. The value of “Type” in a first byte is set to “0”, indicating that the type of multi-display display is the optional arrangement. Furthermore, in a case of this optional arrangement, the arrangement positions of the plurality of display devices 200 are optional, and the information of “ID” in a second byte has no particular meaning, so that this is set to, for example, “Reserved (=0)”. Furthermore, the information portion of “Params” in second to seventh bytes is set to “Reserved (=0)”.

Next, a case where the type of multi-display display is the preset arrangement is described. This preset arrangement means a case where the arrangement of the screens formed by the plurality of display devices 200 is the screen arrangement set in advance as described above. For example, a typical planar arrangement pattern or a case where information of the right eye and information of the left eye are transmitted in separate video streams to create a stereoscopic video is considered.

FIG. 9 illustrates a structure example of information portions of “Type”, “ID”, and “Params” in 10-byte information of “Monitor Location Info” (refer to FIG. 6) in a case where the type of multi-display display is the preset arrangement. A value of “Type” in a first byte is set to any one of “1 to 249” depending on the type of preset arrangement. “ID” in a second byte indicates the arrangement position in the multi-display display of the target display device 200. Furthermore, the information portion of “Params” in second to seventh bytes is set to “Reserved (=0)”.

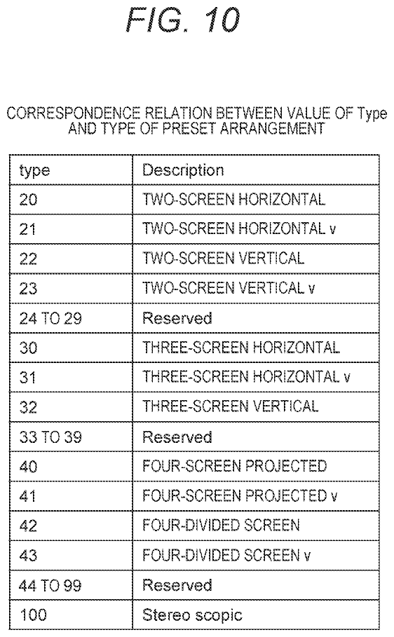

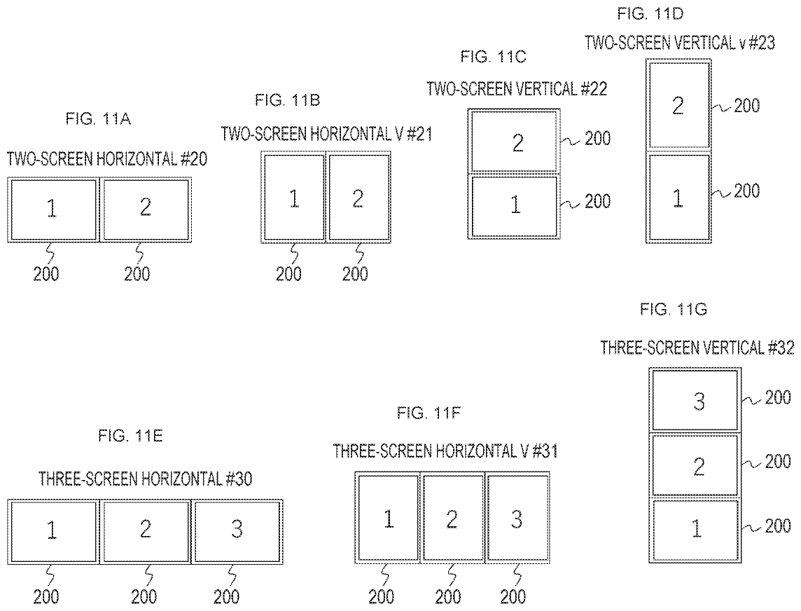

FIG. 10 illustrates an example of a correspondence relation between the value of “Type” and the type of preset arrangement. It is indicated by “20” that the type of preset arrangement is “two-screen horizontal” in which the two display devices 200 are arranged in a horizontal direction in a horizontal placement state as illustrated in FIG. 11 (a). In this case, the identifiers “ID” of the arrangement positions of the two display devices 200 are defined as, for example, “1” for a left one and “2” for a right one as illustrated in the drawing.

Furthermore, “21” indicates that the type of preset arrangement is “two-screen horizontal v” in which the two display devices 200 are arranged in a horizontal direction in a vertical placement state as illustrated in FIG. 11 (b). Here, “v” indicates that the display device 200 is arranged in a vertical placement state. This similarly applies to the following. In this case, the identifiers “ID” of the arrangement positions of the two display devices 200 are defined as, for example, “1” for a left one and “2” for a right one as illustrated in the drawing.

Furthermore, “22” indicates that the type of preset arrangement is “two-screen vertical” in which the two display devices 200 are arranged in a vertical direction in a horizontal placement state as illustrated in FIG. 11 (c). In this case, the identifiers “ID” of the arrangement positions of the two display devices 200 are defined as, for example, “1” for a lower one and “2” for an upper one as illustrated in the drawing.

Furthermore, “23” indicates that the type of preset arrangement is “two-screen vertical v” in which the two display devices 200 are arranged in a vertical direction in a vertical placement state as illustrated in FIG. 11 (d). In this case, the identifiers “ID” of the arrangement positions of the two display devices 200 are defined as, for example, “1” for a lower one and “2” for an upper one as illustrated in the drawing.

Furthermore, “30” indicates that the type of preset arrangement is “three-screen horizontal” in which the three display devices 200 are arranged in a horizontal direction in a horizontal placement state as illustrated in FIG. 11 (e). In this case, the identifiers “ID” of the arrangement positions of the three display devices 200 are defined as, for example, “1” for a left one, “2” for a central one, and “3” for a right one as illustrated in the drawing.

Furthermore, “31” indicates that the type of preset arrangement is “three-screen horizontal v” in which the three display devices 200 are arranged in a horizontal direction in a vertical placement state as illustrated in FIG. 11 (f). In this case, the identifiers “ID” of the arrangement positions of the three display devices 200 are defined as, for example, “1” for a left one, “2” for a central one, and “3” for a right one as illustrated in the drawing.

Furthermore, “32” indicates that the type of preset arrangement is “three-screen vertical” in which the three display devices 200 are arranged in a vertical direction in a horizontal placement state as illustrated in FIG. 11 (g). In this case, the identifiers “ID” of the arrangement positions of the three display devices 200 are defined as, for example, “1” for a lower one, “2” for a central one, and “3” for an upper one as illustrated in the drawing.

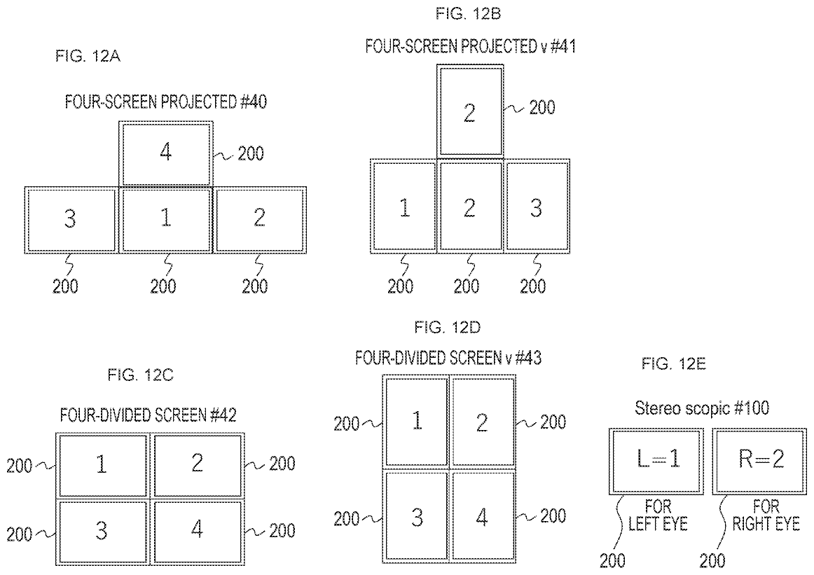

Furthermore, “40” indicates that the type of preset arrangement is “four-screen projected” in which the four display devices 200 are arranged in a projected shape in a horizontal placement state as illustrated in FIG. 12 (a). In this case, the identifiers “ID” of the arrangement positions of the four display devices 200 are defined as, for example, “1” for a lower central one, “2” for a lower right one, “3” for a lower left one, and “4” for an upper one as illustrated in the drawing.

Furthermore, “41” indicates that the type of preset arrangement is “four-screen projected v” in which the four display devices 200 are arranged in a projected shape in a vertical placement state as illustrated in FIG. 12 (b). In this case, the identifiers “ID” of the arrangement positions of the four display devices 200 are defined as, for example, “1” for a lower central one, “2” for a lower right one, “3” for a lower left one, and “4” for an upper one as illustrated in the drawing.

Furthermore, “42” indicates that the type of preset arrangement is “four-divided screen” in which the four display devices 200 are arranged in a square lattice pattern in a horizontal placement state as illustrated in FIG. 12 (c). In this case, the identifiers “ID” of the arrangement positions of the four display devices 200 are defined as, for example, “1” for an upper left one, “2” for an upper right one, “3” for a lower left one, and “4” for a lower right one as illustrated in the drawing.

Furthermore, “43” indicates that the type of preset arrangement is “four-divided screen v” in which the four display devices 200 are arranged in a square lattice pattern in a vertical placement state, as illustrated in FIG. 12 (d). In this case, the identifiers “ID” of the arrangement positions of the four display devices 200 are defined as, for example, “1” for an upper left one, “2” for an upper right one, “3” for a lower left one, and “4” for a lower right one as illustrated in the drawing.

Furthermore, “100” indicates that the type of preset arrangement is “stereo scopic” in which the two display devices 200 for a left eye and for a right eye are arranged in a horizontal direction in a horizontal placement state as illustrated in FIG. 12 (e). In this case, the identifier “ID” of the arrangement positions of the two display devices 200 are defined as “1” for the left eye and “2” for the right eye.

Note that, in one example of the correspondence relation in FIG. 10, the types of preset arrangement of up to four display devices 200 are illustrated, but the types of preset arrangement are not limited thereto, and the types of preset arrangement including other number of display devices 200 are also conceivable, although detailed description thereof is omitted.

Next, a case where the type of multi-display display is the planar arrangement is described. The planar arrangement means a case where the components such as the size of each screen can be freely set in a case where one flat screen is created by combining screens formed by the plurality of display devices 200 as described above. In this case, the screen size and resolution of the plurality of display devices 200 can be freely set, and information thereof is arranged in the information portion of “Params”.

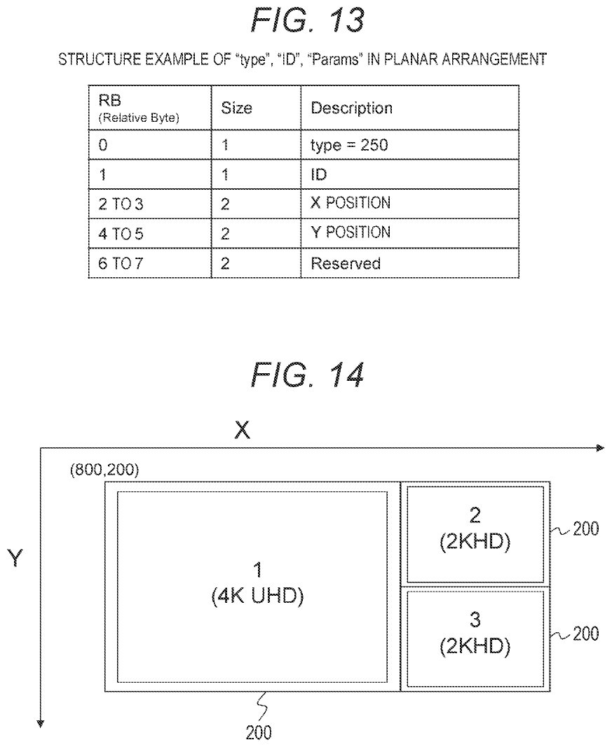

FIG. 13 illustrates a structure example of information portions of “Type”, “ID”, and “Params” in 10-byte information of “Monitor Location Info” (refer to FIG. 6) in a case where the type of multi-display display is the planar arrangement. A value of “Type” in a first byte is set to “250”, indicating that the type of multi-display display is the planar arrangement.

“ID” in a second byte indicates the arrangement position in the multi-display display of the target display device 200. Furthermore, in the information portion of “Params” in second to seventh bytes, information of an X position is arranged in the second to third bytes, information of a Y position is arranged in the fourth to fifth bytes, and the other bytes are set to “Reserved (=0)”. Here, the X position and Y position indicate pixel positions at a position on an upper left end of the screen in pixels as a unit.

FIG. 14 illustrates a specific example of the planar arrangement. This example is an example of creating one flat screen by combining one 4KUHD screen and two 2KHD screens having a half the size thereof. In this case, a case where main information and two pieces of sub information are simultaneously displayed is conceivable. For example, a usage of displaying a video of a sport relay on a main screen, displaying a video from another camera on one sub screen, and displaying data information of a player on the other sub screen and the like is conceivable.

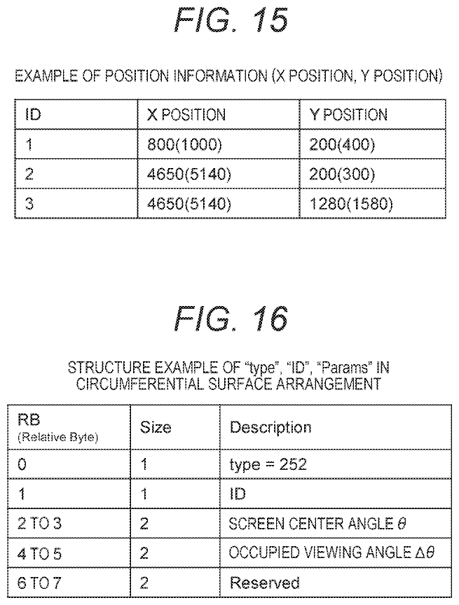

FIG. 15 illustrates information of the X position and Y position when “ID” is 1 to 3 in the specific example of the planar arrangement in FIG. 14. In this case, the X position and Y position when “ID” is 2 and 3 are calculated supposing that the position of 4K video is shifted to a coordinate position on the upper left of the screen when “ID” is 1. Furthermore, in a case where there is a portion where the video is not displayed as a frame portion between the screens, the number of pixels of the frame portion is added as a margin. In FIG. 15, numerical values in parentheses indicate the X position and Y position in a case of forming a margin of UHD:200.HD:100 on the top, bottom, right, and left.

Next, a case where the type of multi-display display is the circumferential surface arrangement is described. The circumferential surface arrangement means a case where the plurality of display devices 200 is arranged on the circumferential surface to create the panoramic screen as described above.

FIG. 16 illustrates a structure example of information portions of “Type”, “ID”, and “Params” in 10-byte information of “Monitor Location Info” (refer to FIG. 6) in a case where the type of multi-display display is the circumferential surface arrangement. A value of “Type” in a first byte is set to “252”, indicating that the type of multi-display display is the circumferential surface arrangement.

“ID” in a second byte indicates the arrangement position in the multi-display display of the target display device 200. Furthermore, in the information portion of “Params” in second to seventh bytes, information of a screen center angle θ is arranged in second to third bytes, information of an occupied viewing angle 40 is arranged in the fourth to fifth bytes, and the other bytes are set to “Reserved (=0)”.

In the circumferential surface arrangement, the plurality of display devices 200 creates the circumferential surface to create the panoramic screen. The screen center angle θ at each display position 200 is a deviation angle of the screen formed by the display device 200 from a center screen. Furthermore, the occupied viewing angle Δθ in each display device 200 indicates the viewing angle in the horizontal direction of the screen formed by the display device.

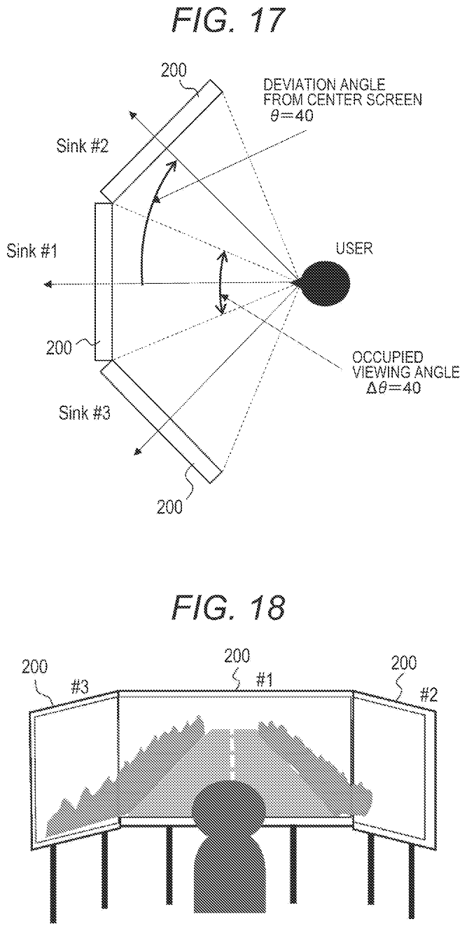

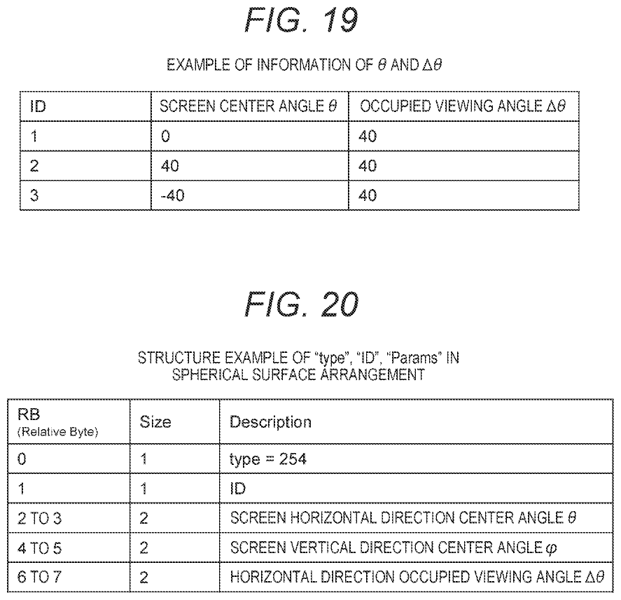

FIGS. 17 and 18 illustrate an arrangement configuration example of the display devices 200 in a case where the type of multi-display display is the circumferential surface arrangement. In this example, three display devices 200 are arranged along the circumferential surface. In this example, 360 degrees of the circumferential surface can be expressed by nine display devices 200, and three display devices 200 are actually arranged along the circumferential surface. In this case, the screen formed by each display device 200 can express the viewing angle of 40 degrees. FIG. 19 illustrates information of the screen center angle θ and the occupied viewing angle Δθ when “ID” is 1 to 3 in the circumferential surface arrangement example in FIGS. 17 and 18.

As for this circumferential surface arrangement, for example, development to a game using a panoramic screen, for example, a race game and the like is conceivable. In this case, video of the front is displayed on the display device 200 placed at the center, and videos of the visual fields directed right and left from the center are displayed on the two display devices 200 placed on the right and left.

Next, a case where the type of multi-display display is the spherical surface arrangement is described. The spherical surface arrangement means a case where the plurality of display devices 200 is arranged on the spherical surface to create the celestial screen as described above.

FIG. 20 illustrates a structure example of information portions of “Type”, “ID”, and “Params” in 10-byte information of “Monitor Location Info” (refer to FIG. 6) in a case where the type of multi-display display is the spherical surface arrangement. A value of “Type” in a first byte is set to “254”, indicating that the type of multi-display display is the spherical surface arrangement.

“ID” in a second byte indicates the arrangement position in the multi-display display of the target display device 200. Furthermore, in the information portion of “Params” in second to seventh bytes, information of a screen horizontal direction center angle θ is arranged in the second to third bytes, information of a screen vertical direction center angle φ is arranged in the fourth to fifth bytes, and information of a horizontal direction occupied viewing angle Δθ is arranged in the sixth to seventh bytes.

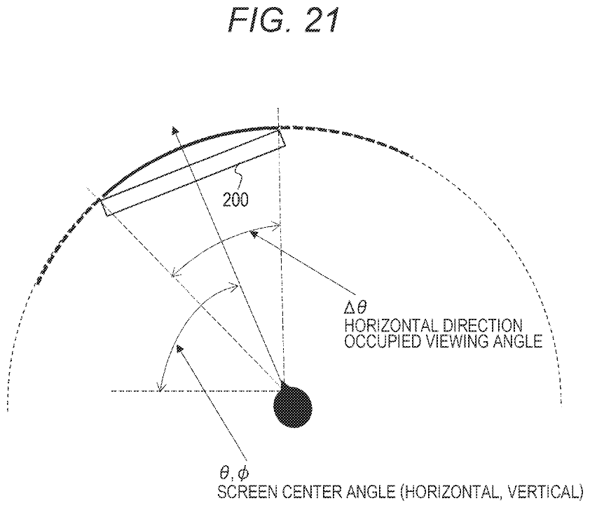

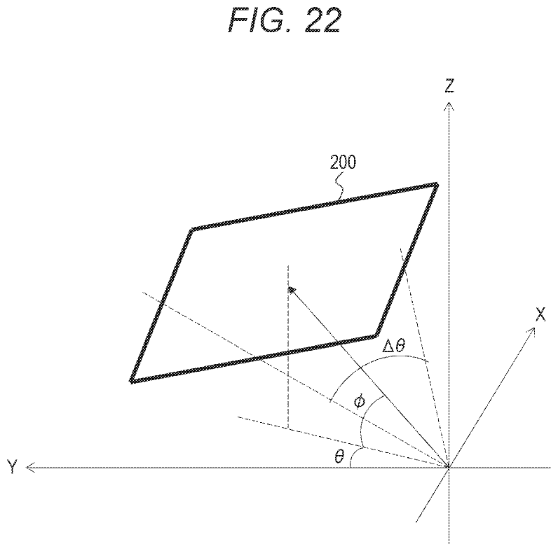

Note that, since an aspect ratio of the screen of the display device 200 is 16:9, the vertical direction occupied viewing angle can be obtained by multiplying the horizontal direction occupied viewing angle Δθ by 9/16. Note that, it is also conceivable to arrange the vertical direction occupied viewing angle instead of the horizontal direction occupied viewing angle Δθ in the information portion of “Params” in the second to seventh bytes. FIGS. 21 and 22 conceptually illustrate the screen horizontal direction center angle θ, screen vertical direction center angle φ, and horizontal direction occupied viewing angle Δθ in a case where the display device 200 is arranged on the spherical surface.

As for this spherical surface arrangement, for example, development to an entertainment display system and the like in which a video content is reproduced in a celestial shape is conceivable.

Referring back to FIG. 1, the video signal output device 100 generates the video stream for each of the plurality of display devices 200 on the basis of the multi-stream information received from the video signal processing device 300. In this case, the video stream for each of the plurality of display devices 200 corresponds to the type of multi-display display indicated by the multi-stream information, and is generated in the video format handled by each display device 200.

Then, the video signal output device 100 generates the multi-stream including the video stream for each of the plurality of display devices 200 and transmits the same to the video signal processing device 300. In this case, the video signal output device 100 transmits this multi-stream to the video signal processing device 300 using, for example, a fixed rate link (FRL) packet structure. In this case, for example, an identifier required for identification of a plurality of video streams is newly defined. As a specific example, when a 4-bit identifier is defined in a Reserved region of Map Type of FRL, up to 16 streams can be multiplexed.

Here, each video stream included in the multi-stream includes information indicating to which display device 200 the video stream corresponds. This information is inserted into the video stream using, for example, an InfoFrame or an extended metadata packet (EMP).

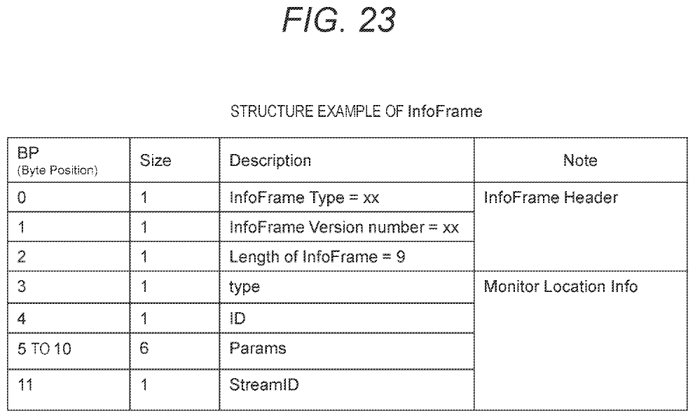

FIG. 23 illustrates a structure example of the InfoFrame. First to third bytes form header portion of the InfoFrame, in which information of an InfoFrame type, a version number, and a byte length of a data byte are arranged. Third to eleventh bytes form a data byte portion of the InfoFrame, in which 9-byte information of “Monitor Location Info” is arranged.

Information of “Type” is arranged in the third byte. Information of “ID” is arranged in the fourth byte. Information of “Params” is arranged in the fifth to tenth bytes. Then, information of “StreamID” is arranged in the eleventh byte. Although detailed description is omitted, as described above, these pieces of information are the same as the information included in the information of “Monitor Location Info” (refer to FIG. 6) forming the multi-stream information transmitted from the video signal processing device 300 to the video signal output device 100.

Here, as described above, the information of “StreamID” corresponds to the HDMI output terminal of the video signal processing device 300 to which the target display device 200 is connected, and is information indicating to which display device 200 the video stream including this information corresponds.

Referring back to FIG. 1, the video signal processing device 300 extracts the plurality of video streams out of the multi-stream transmitted from the video signal output device 100, and transmits each of them to a corresponding display device 200 out of the plurality of display devices 200. In this case, each video stream is output to the HDMI output terminal corresponding to “StreamID” in the InfoFrame inserted thereinto, thereby being transmitted to the corresponding display device 200.

Each of the plurality of display devices 200 displays video on the basis of the video stream transmitted from the video signal processing device 300. Therefore, the plurality of display devices 200 performs the multi-display display of the type set by the video signal processing device 300.

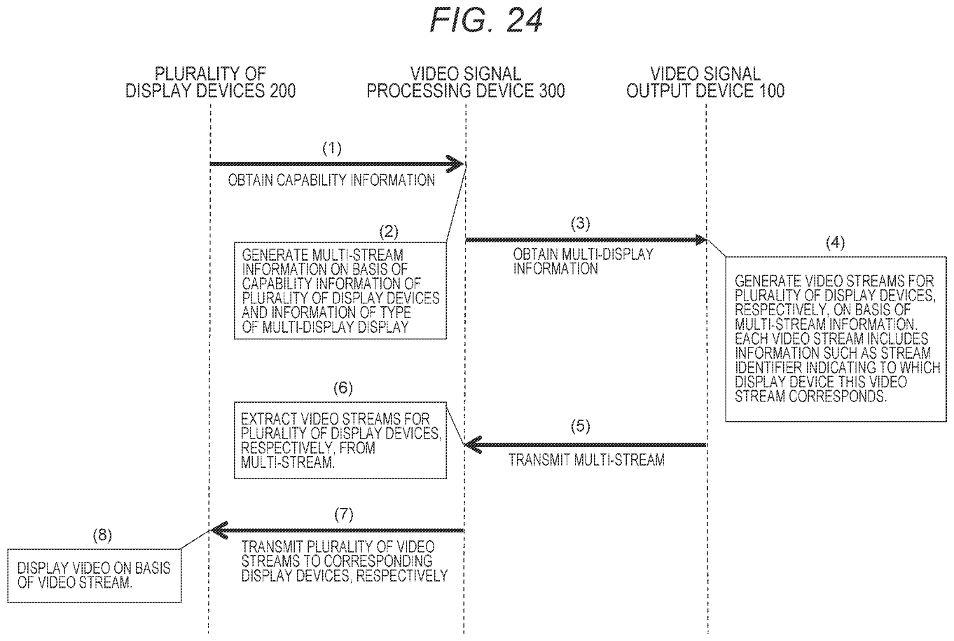

FIG. 24 illustrates an operation sequence of the multi-display system 10 illustrated in FIG. 1.

(1) Initially, the video signal processing device 300 obtains the capability information from each of the plurality of display devices 200. In this case, the video signal processing device 300 reads the EDID including the capability information through a DDC line as a HPD signal changes from low to high when the display device 200 is connected.

(2) Next, the video signal processing device 300 generates the multi-stream information on the basis of the capability information transmitted from the plurality of display devices 200 and the information of the type of multi-display display implemented by the plurality of display devices 200. The multi-stream information is generated as the EDID or SCDCS data. That is, the EDID extension block (refer to FIG. 4) including the multi-stream information or the information block of the SCDCS data (refer to FIG. 5) including the multi-stream information is generated.

(3) Next, the video signal output device 100 obtains the multi-stream information from the video signal processing device 300. In a case where the video signal processing device 300 generates the EDID extension block including the multi-stream information, the video signal output device 100 reads the EDID extension block through the DDC line as the HPD signal changes from low to high after the generation of the EDID extension block. In contrast, in a case where the video signal processing device 300 generates the information block of the SCDCS data including the multi-stream information, the video signal output device 100 reads the information block of the SCDCS data through the DDC line as a Read request is issued from the video signal processing device 300 after the information block of the SCDCS data is generated.

(4) Next, the video signal output device 100 generates the video stream for each of the plurality of display devices 200 on the basis of the multi-stream information. In this case, the video stream for each of the plurality of display devices 200 corresponds to the type of multi-display display indicated by the multi-stream information, and is generated in the video format handled by each display device 200. Into each video stream, information indicating to which display device 200 this video stream corresponds, for example, information of “StreamID” is inserted. This information is inserted using, for example, the InfoFrame (refer to FIG. 23).

(5) Next, the video signal output device 100 generates the multi-stream including the video stream for each of the plurality of display devices 200 and transmits the same to the video signal processing device 300. In this case, the video signal output device 100 transmits this multi-stream to the video signal processing device 300 using, for example, the FRL packet structure.

(6) Next, the video signal processing device 300 extracts the video stream for each of the plurality of display devices 200 from the multi-stream.

(7) Next, the video signal processing device 300 transmits the plurality of video streams extracted from the multi-stream to the corresponding display device 200. In this case, each video stream is output to the HDMI output terminal corresponding to “StreamID” in the InfoFrame, for example, thereby being transmitted to the corresponding display device 200.

(8) Then, each of the plurality of display devices 200 displays the video on the basis of the video stream transmitted from the video signal processing device 300. Therefore, the plurality of display devices 200 performs the multi-display display of the type set by the video signal processing device 300.

### [Configuration Example of Video Signal Output Device, Video Signal Processing Device, and Display Device]

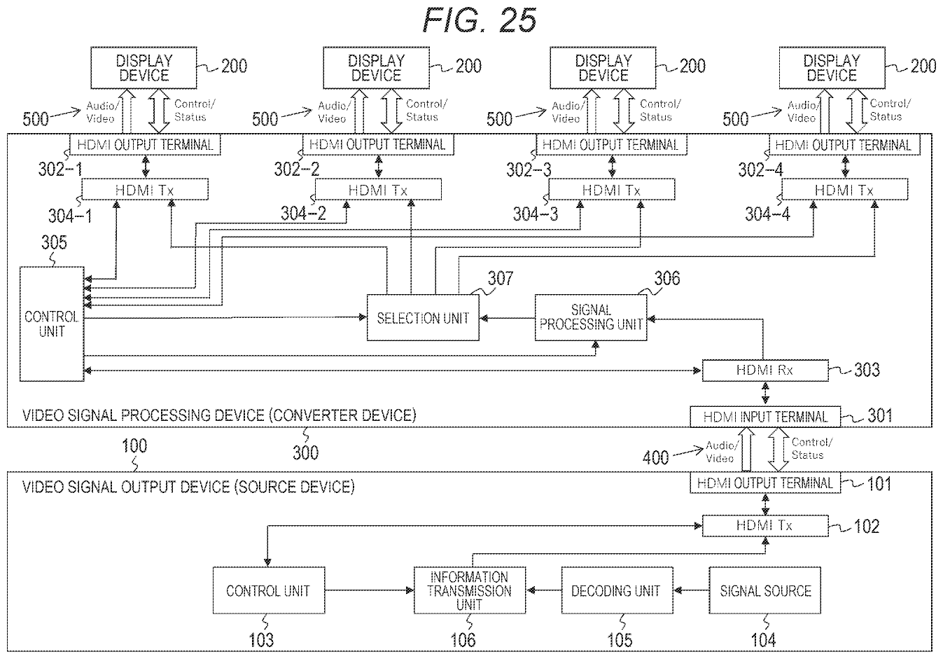

FIG. 25 illustrates a configuration example of the video signal output device 100 and the video signal processing device 300. In this example, the video signal processing device 300 includes four HDMI output terminals 302-1 to 302-4, and the display device 200 is connected to each of them. Note that, even in a case where the four HDMI output terminals 302-1 to 302-4 are provided, the display device 200 is not always connected to all the terminals depending on the type of multi-display display.

The video signal processing device 100 includes the HDMI output terminal 101, an HDMI transmission unit (HDMI Tx) 102, a control unit 103, a signal source 104, a decoding unit 105, and an information transmission unit 106.

Furthermore, the video signal processing device 300 includes an HDMI input terminal 301, an HDMI reception unit (HDMI Rx) 303, the four HDMI output terminals 302-1 to 302-4, four HDMI transmission units (HDMI Tx) 304-1 to 304-4, a control unit 305, a signal processing unit 306, and a selection unit 307.

The control unit 305 of the video signal processing device 300 generates the multi-stream information on the basis of the capability information of each display device 200 obtained through the HDMI transmission units (HDMI Tx) 304-1 to 304-4 and the type of multi-display display, and generates the EDID extension block (refer to FIG. 4) including this multi-stream information or the information block of the SCDCS data (refer to FIG. 5) including the multi-stream information.

The control unit 305 of the video signal output device 100 reads the EDID extension block or the information block of the SCDCS data including the multi-stream information from the video signal processing device 300 through the HDMI transmission unit (HDMI Tx) 102, and acquires the multi-stream information.

Under the control of the control unit 103, the video signal output device 100 generates the video streams for the four display devices 200 on the basis of the multi-stream information, and transmits the multi-stream including the video streams to the video signal processing device 300 through the HDMI transmission unit (HDMI Tx) 102.

In this case, compressed data corresponding to the type of multi-display display is read from the signal source 104, and the compressed data is subjected to decoding processing by the decoding unit 105 to be supplied to the information transmission unit 106. The information transmission unit 106 generates the video streams for the four display devices 200 on the basis of the multi-stream information. In this case, into each video stream, information indicating to which display device 200 this video stream corresponds, for example, the InfoFrame including the information of “StreamID” and the like is inserted.

Then, in the information transmission unit 106, the multi-stream including the video streams for the four display devices 200 is generated, and the multi-steam is transmitted to the video signal processing device 300 through the HDMI transmission unit (HDMI Tx) 102.

Under the control of the control unit 305, the video signal processing device 300 extracts the video streams for the four display devices 200 from the multi-stream received by the HDMI reception unit 303, and transmits the same to the corresponding display devices 200.

In this case, the multi-stream received by the HDMI reception unit 303 is supplied to the signal processing unit 306, and the video streams for the four display devices 200 are extracted from the multi-stream. Each video stream extracted by the signal processing unit 306 is transmitted to the selection unit 307. In the selection unit 307, each video stream is output to the HDMI output terminal corresponding to “StreamID” in the InfoFrame, thereby being transmitted to the corresponding display device 200.

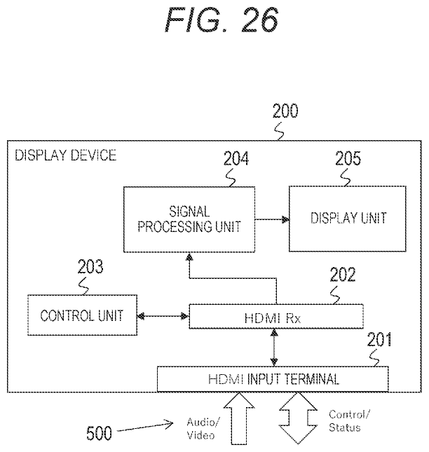

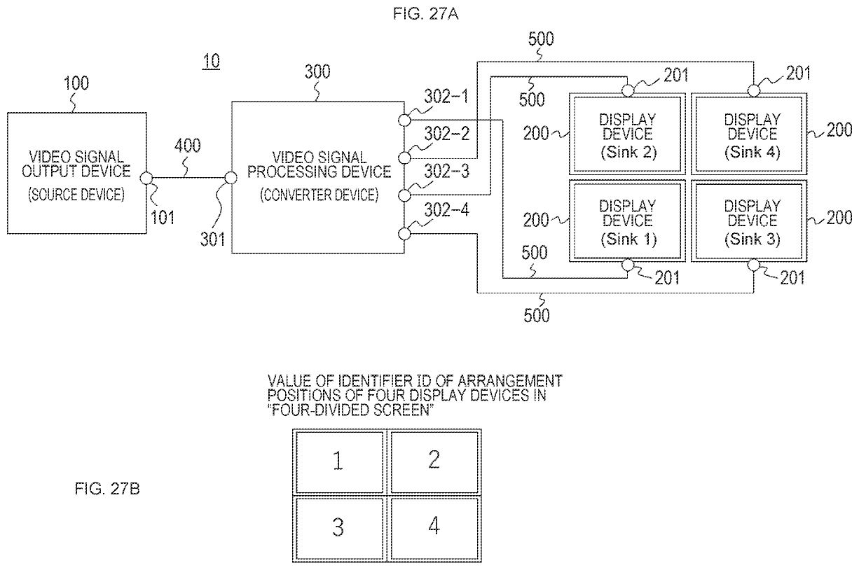

FIG. 26 illustrates a configuration example of the display device 200. The display device 200 includes the HDMI input terminal 201, an HDMI reception unit (HDMI Rx) 202, a control unit 203, a signal processing unit 204, and a display unit 205.

The control unit 203 controls an operation of each unit of the display device 200. The video stream received by the HDMI reception unit 202 from the video signal processing device 300 is transmitted to the signal processing unit 204. The signal processing unit 204 performs processing such as scaling and contour enhancement on the video stream to obtain a video signal for display. The display unit 205 performs video display using the video signal for display obtained by the signal processing unit 204. The display unit 205 includes, for example, a liquid crystal display (LCD), an organic electro luminescence (EL) and the like.

### [Specific Example of Multi-Display Display]

Details of the multi-stream information and the like in a specific example of the multi-display display will be described. Here, as illustrated in FIG. 27 (a), an example will be described in which the type of multi-display display is the preset arrangement, and the type of preset arrangement is “four-divided screen” (refer to FIG. 10) in which the four display devices 200 are arranged in a square lattice pattern in a horizontal placement state. FIG. 27 (b) illustrates values of the identifier ID at the arrangement positions of the four display devices 200 arranged in a square lattice pattern when the type of preset arrangement is “four-divided screen”.

In the example in FIG. 27 (a), a display device (sink 1) 200 arranged at an arrangement position of ID=3 is connected to the output terminal 302-1 corresponding to an output 1 of the video signal processing device 300, a display device (sink 4) 200 arranged at an arrangement position of ID=2 is connected to the output terminal 302-2 corresponding to an output 2 of the video signal processing device 300, the display device (sink 2) 200 arranged at an arrangement position of ID=1 is connected to the output terminal 302-3 corresponding to an output 3 of the video signal processing device 300, and the display device (sink 3) 200 arranged at an arrangement position of ID=4 is connected to the output terminal 302-4 corresponding to an output 4 of the video signal processing device 300.

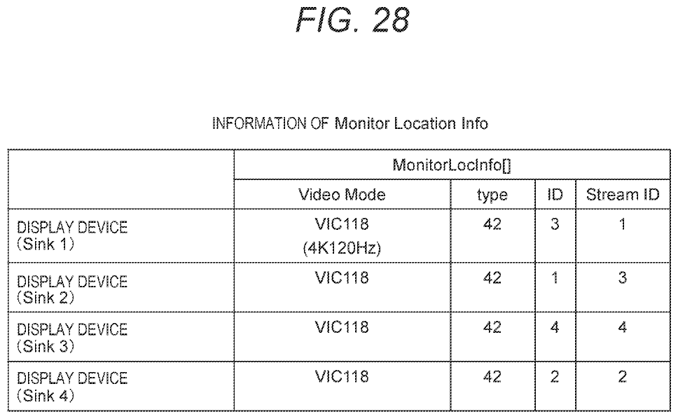

In this case, the “Monitor Location Info” information corresponding to each display device 200 included in the multi-stream information generated by the video signal processing device 300 is as illustrated in FIG. 28.

Here, “VideoMode=VIC 118” is set for all the display devices 200, indicating that the display devices are compatible with the video format of 4 K 120 Hz. Note that, “VIC118” is an example, and there is no limitation. Furthermore, “type=42” is set for all the display devices 200, indicating that the type of multi-display display is “four-divided screen” in which four display devices 200 are arranged in a square lattice pattern in a horizontal placement state.

Furthermore, regarding the display device (sink 1) 200, “ID=3” is set, indicating that the arrangement position of the display device (sink 1) 200 is the position “3” in the multi-display display of the “four-divided screen”. Furthermore, regarding the display device (sink 1) 200, “Stream ID=1” is set, indicating that “1” is used as “Stream ID” of the video stream for the display device (sink 1) 200 and that the display device (sink 1) 200 is connected to the output terminal 302-1 corresponding to the output 1 of the video signal processing device 300.

Furthermore, regarding the display device (sink 2) 200, “ID=1” is set, indicating that the arrangement position of the display device (sink 1) 200 is the position “1” in the multi-display display of the “four-divided screen”. Furthermore, regarding the display device (sink 2) 200, “Stream ID=3” is set, indicating that “3” is used as “Stream ID” of the video stream for the display device (sink 2) 200 and that the display device (sink 2) 200 is connected to the output terminal 302-3 corresponding to the output 3 of the video signal processing device 300.

Furthermore, regarding the display device (sink 3)200, “ID=4” is set, indicating that the arrangement position of the display device (sink 1) 200 is the position “4” in the multi-display display of the “four-divided screen”. Furthermore, regarding the display device (sink 3) 200, “Stream ID=3” is set, indicating that “4” is used as “Stream ID” of the video stream for the display device (sink 3) 200 and that the display device (sink 3) 200 is connected to the output terminal 302-4 corresponding to the output 4 of the video signal processing device 300.

Furthermore, regarding the display device (sink 4) 200, “ID=2” is set, indicating that the arrangement position of the display device (sink 1) 200 is the position “2” in the multi-display display of the “four-divided screen”. Furthermore, regarding the display device (sink 4) 200, “Stream ID=2” is set, indicating that “2” is used as “Stream ID” of the video stream for the display device (sink 4) 200 and that the display device (sink 4) 200 is connected to the output terminal 302-2 corresponding to the output 2 of the video signal processing device 300.

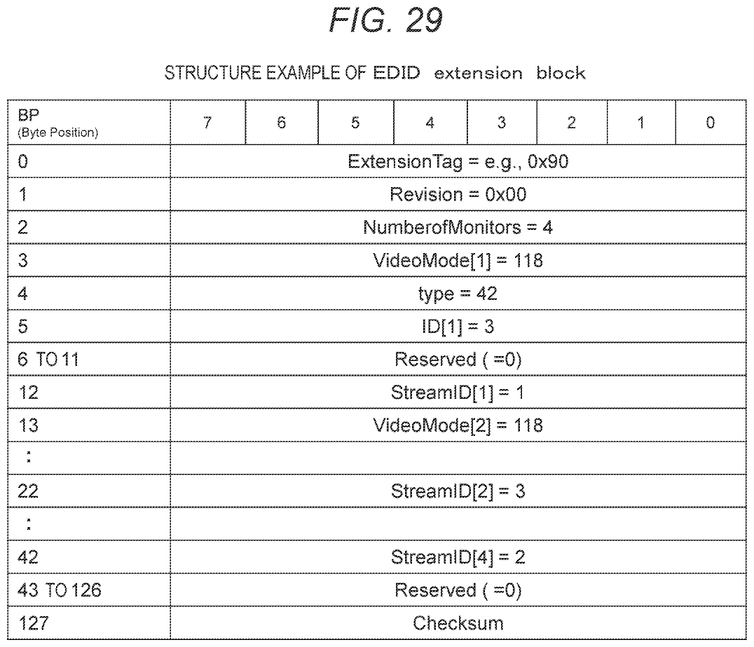

FIG. 29 illustrates a structure example of an EDID extension block including “Monitor Location Info” information corresponding to the four display devices 200 in FIG. 28.

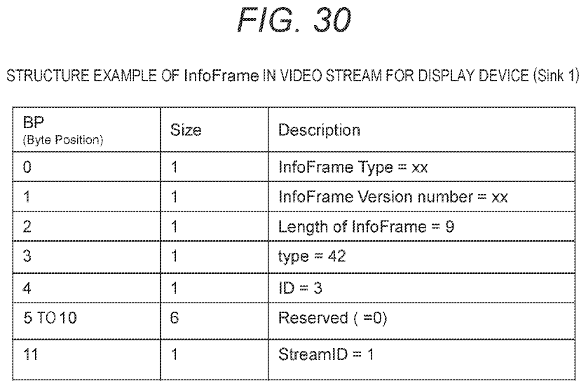

FIG. 30 illustrates a structure example of the InfoFrame inserted into the video stream for the display device (sink 1) 200 generated by the video signal output device 100. The video signal processing device 300 can recognize that this video stream is the video stream for the display device (sink 1) 200 connected to the HDMI output terminal 302-1 of the output 1 from the information of “Stream ID=1”, and can easily output this video stream to the HDMI output terminal 302-1 and transmit the same to the display device (sink 1) 200. Furthermore, the video signal processing device 300 can confirm that this video stream is the video stream for the display device 200 arranged at the position “3” in the multi-display display of the “four-divided screen”, from the information of “type=42” and the information of “ID=3”.

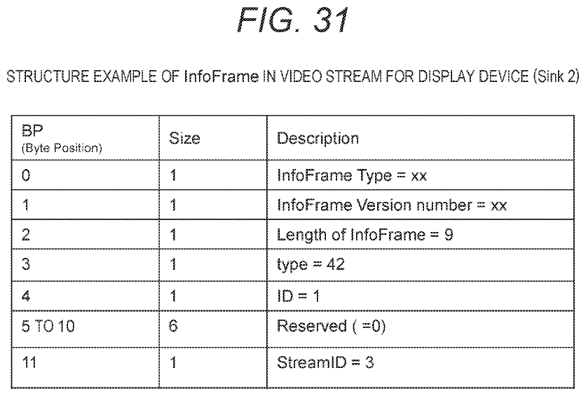

FIG. 31 illustrates a structure example of the InfoFrame inserted into the video stream for the display device (sink 2) 200 generated by the video signal output device 100. The video signal processing device 300 can recognize that this video stream is the video stream for the display device (sink 2) 200 connected to the HDMI output terminal 302-3 of the output 3 from the information of “Stream ID=3”, and can easily output this video stream to the HDMI output terminal 302-3 and transmit the same to the display device (sink 2) 200. Furthermore, the video signal processing device 300 can confirm that this video stream is the video stream for the display device 200 arranged at the position “1” in the multi-display display of the “four-divided screen”, from the information of “type=42” and the information of “ID=1”.

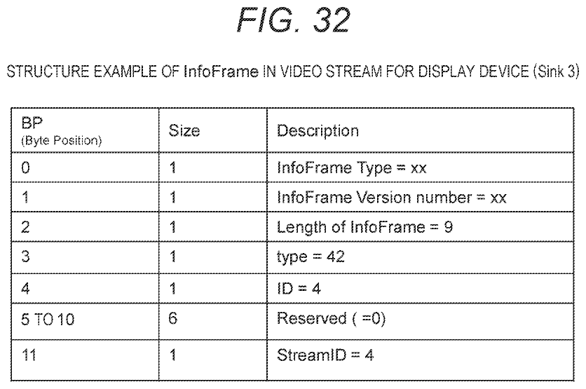

FIG. 32 illustrates a structure example of the InfoFrame inserted into the video stream for the display device (sink 3) 200 generated by the video signal output device 100. The video signal processing device 300 can recognize that this video stream is the video stream for the display device (sink 3) 200 connected to the HDMI output terminal 302-4 of the output 4 from the information of “Stream ID=4”, and can easily output this video stream to the HDMI output terminal 302-4 and transmit the same to the display device (sink 3) 200. Furthermore, the video signal processing device 300 can confirm that this video stream is the video stream for the display device 200 arranged at the position “4” in the multi-display display of the “four-divided screen”, from the information of “type=42” and the information of “ID=4”.

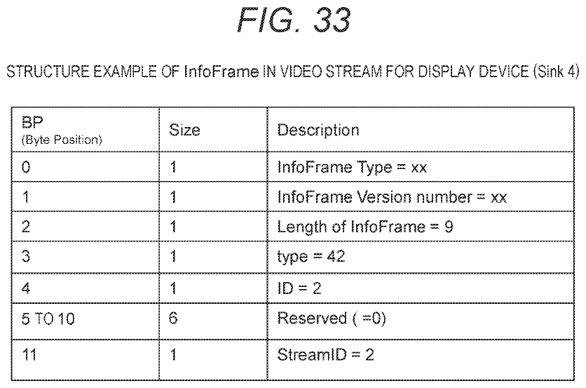

FIG. 33 illustrates a structure example of the InfoFrame inserted into the video stream for the display device (sink 4) 200 generated by the video signal output device 100. The video signal processing device 300 can recognize that this video stream is the video stream for the display device (sink 4) 200 connected to the HDMI output terminal 302-2 of the output 2 from the information of “Stream ID=2”, and can easily output this video stream to the HDMI output terminal 302-2 and transmit the same to the display device (sink 4) 200. Furthermore, the video signal processing device 300 can confirm that this video stream is the video stream for the display device 200 arranged at the position “2” in the multi-display display of the “four-divided screen”, from the information of “type=42” and the information of “ID=2”.

### [Audio Processing During Multi-Stream Transmission]

Audio processing during multi-stream transmission will be described. As the audio processing in this case, both of them are possible: (1) independent processing without association with a position where the display device 200 that reproduces the audio is arranged, and (2) processing of associating with the position where the display device 200 that reproduces the audio is arranged similarly to the video.

In a case of the independent processing without association, when a plurality of audios is transmitted corresponding to each of a plurality of video streams, one display device 200 selected by the user out of the plurality of display devices 200 forming the multi-display system 10 outputs audio. Furthermore, in a case of the independent processing without association, when one audio is transmitted corresponding to only one video stream out of the plurality of video streams, the display device 200 that receives the one audio out of the plurality of display devices 200 forming the multi-display system 10 outputs the audio.

In contrast, in a case of the processing of associating, each of the plurality of display devices 200 forming the multi-display system 10 outputs the audio transmitted together with the video stream from its own speaker. Therefore, it is possible to implement a realistic feeling in which the audio (sound) generated by an object is issued from the object displayed on the screen of each display device 200.

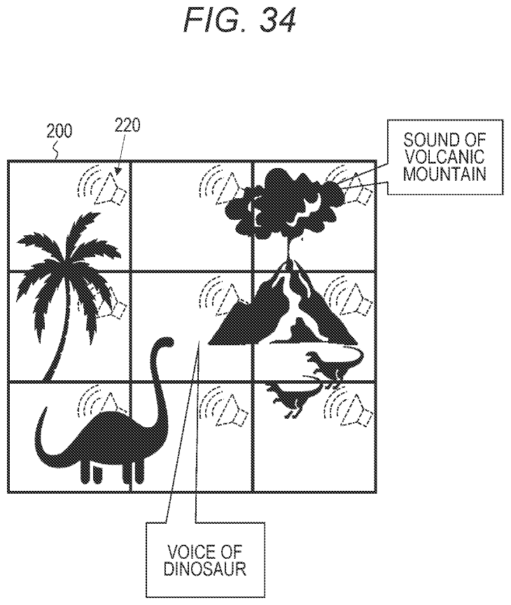

FIG. 34 illustrates an image diagram of a use case. In this case, nine display devices 200 are arranged in a lattice pattern, and each display device 200 includes a speaker 220 that outputs audio. In a case of this use case, in the display device 200 in which the top portion of the volcanic mountain is displayed, the sound of the volcanic mountain is output from the speaker 220 of the display device 200. Furthermore, in the display device 200 in which the head portion of the dinosaur is displayed, the sound of the dinosaur is output from the speaker 220 of the display device 200.

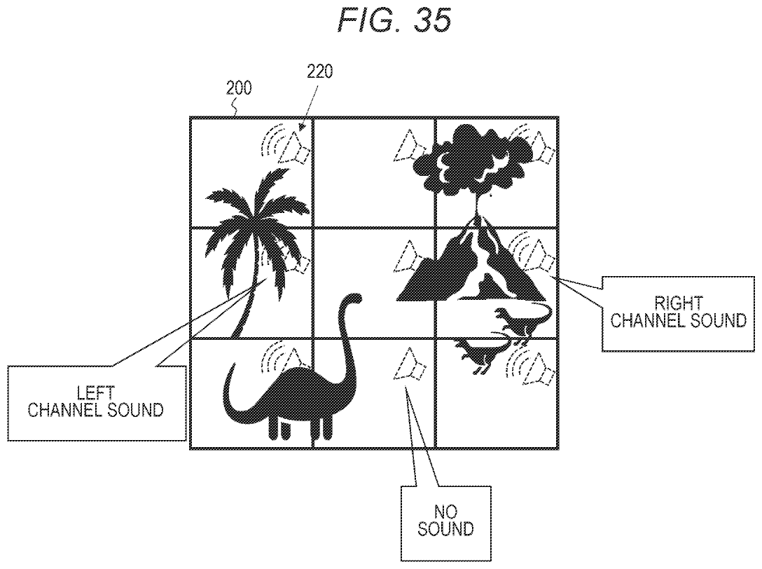

Furthermore, FIG. 35 illustrates an image diagram of another use case. In this case, as in FIG. 34, nine display devices 200 are arranged in a lattice pattern, and each display device 200 includes a speaker 220 that outputs audio. In a case of this use case, the left channel sound is output from the speakers 220 of the three display devices 200 on the left side, and the right channel sound is output from the speakers 220 of the three display devices 200 on the right side.

As described above, in the multi-display system 10 illustrated in FIG. 1, the video signal processing device 300 receives the capability information from each of a plurality of display devices 200, generates the multi-stream information on the basis of the capability information of the plurality of display devices 200 and the information of the type of multi-display display implemented by the plurality of display devices 200, and transmitting the multi-stream information to the video signal output device 100, receives, from the video signal output device 100, the multi-stream including the video streams for the plurality of display devices 200, respectively, generated on the basis of the multi-stream information, and extracts the plurality of video streams from the multi-stream and transmits each of the plurality of video streams to the corresponding display device 200 out of the plurality of display devices 200. Therefore, an appropriate video stream corresponding to the type of multi-display display can be supplied to each of the plurality of display devices 200, and the multi-display display corresponding to the type of multi-display display can be satisfactorily implemented.

### 2. Variation

Note that, in the above-described embodiment, an example of the multi-display system 10 including the video signal output device 100, the video signal processing device 300, and the plurality of display devices 200 has been described. However, it is also conceivable to form a multi-display system capable of satisfactorily implementing multi-display display corresponding to a type of multi-display display similarly to the multi-display system 10 using a video signal output device and a plurality of display devices.

In this case, a plurality of display devices (sink devices) is directly connected to a video signal output device (source device). Then, the video signal output device is configured to receive capability information from each of a plurality of display devices, and generate video streams for the plurality of display devices, respectively, on the basis of capability information of the plurality of display devices and information of a type of multi-display display implemented by the plurality of display devices, and transmit each of the video streams to a corresponding display device out of the plurality of display devices.

Furthermore, the preferred embodiment of the present disclosure has been described in detail with reference to the accompanying drawings, but the technical scope of the present disclosure is not limited to such example. It is apparent that a person having ordinary knowledge in the technical field of the present disclosure can conceive of various changes or modifications within the scope of the technical idea recited in claims, and it is to be understood that the various changes or modifications naturally also fall within the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to or instead of the effect described above.

Furthermore, the present technology can also have the following configurations.

(1) A video signal processing device including:
an information reception unit that receives capability information from each of a plurality of display devices;
an information transmission unit that generates multi-stream information on the basis of the capability information of the plurality of display devices and information of a type of multi-display display implemented by the plurality of display devices, and transmits the multi-stream information to a video signal output device;
a multi-stream reception unit that receives, from the video signal output device, a multi-stream including video streams for the plurality of display devices, respectively, generated on the basis of the multi-stream information; and
a video stream transmission unit that extracts the plurality of video streams from the multi-stream and transmits each of the plurality of video streams to a corresponding display device out of the plurality of display devices.

(2) The video signal processing device according to (1) described above, in which
the type of multi-display display includes at least any one of optional arrangement, preset arrangement, planar arrangement, circumferential surface arrangement, or spherical surface arrangement.

(3) The video signal processing device according to (1) or (2) described above, in which
the multi-stream information includes information of the number of the plurality of display devices and information of the type of multi-display display.

(4) The video signal processing device according to (3) described above, in which
the multi-stream information includes stream identification information and arrangement position information corresponding to each of the plurality of display devices.

(5) The video signal processing device according to (3) or (4) described above, in which
in a case where the type of multi-display display is planar arrangement, the multi-stream information includes information of a pixel position on an upper left end of a screen corresponding to each of the plurality of display devices.

(6) The video signal processing device according to (3) or (4) described above, in which in a case where the type of multi-display display is circumferential surface arrangement, the multi-stream information includes information of a screen center angle and information of an occupied viewing angle corresponding to each of the plurality of display devices.

(7) The video signal processing device according to (3) or (4) described above, in which
in a case where the type of multi-display display is spherical surface arrangement, the multi-stream information includes information of a screen horizontal direction center angle, information of a screen vertical direction center angle, and information of an occupied viewing angle in a horizontal direction or a vertical direction corresponding to each of the plurality of display devices.

(8) The video signal processing device according to any one of (3) to (7) described above, in which
the multi-stream information includes information of a video format corresponding to each of the plurality of display devices.

(9) The video signal processing device according to any one of (1) to (8), in which
each video stream included in the multi-stream includes stream identification information indicating the display device to which the video stream corresponds.

(10) A video signal processing method including steps of:
receiving capability information from each of a plurality of display devices;
generating multi-stream information on the basis of the capability information of the plurality of display devices and information of a type of multi-display display implemented by the plurality of display devices, and transmitting the multi-stream information to a video signal output device;
receiving, from the video signal output device, a multi-stream including video streams for the plurality of display devices, respectively, generated on the basis of the multi-stream information; and
extracting the plurality of video streams from the multi-stream and transmitting each of the plurality of video streams to a corresponding display device out of the plurality of display devices.

(11) A video signal output device including:
an information reception unit that receives, from a video signal processing device to which a plurality of display devices is connected, multi-stream information generated on the basis of capability information of the plurality of display devices and information of a type of multi-display display implemented by the plurality of display devices; and
a multi-stream transmission unit that generates a multi-stream including video streams for the plurality of display devices, respectively, on the basis of the multi-stream information, and transmits the multi-stream to the video signal processing device.

(12) A video signal output device including:
an information reception unit that receives capability information from each of a plurality of display devices; and
a video stream transmission unit that generates video streams for the plurality of display devices, respectively, on the basis of the capability information of the plurality of display devices and information of a type of multi-display display implemented by the plurality of display devices, and transmits each of the video streams to a corresponding display device out of the plurality of display devices.

(13) A multi-display system including:

a video signal output device and a plurality of display devices connected to each other via a video signal processing device, in which
the video signal processing device:
receives capability information from each of the plurality of display devices;
generates multi-stream information on the basis of the capability information of the plurality of display devices and information of a type of multi-display display implemented by the plurality of display devices, and transmits the multi-stream information to the video signal output device;
receives, from the video signal output device, a multi-stream including video streams for the plurality of display devices, respectively, generated on the basis of the multi-stream information; and
extracts the plurality of video streams from the multi-stream and transmits each of the plurality of video streams to a corresponding display device out of the plurality of display devices.

### REFERENCE SIGNS LIST

10 Multi-display system
100 Video signal output device (source device)
101 HDMI output terminal
102 HDMI transmission unit
103 Control unit
104 Signal source
105 Decoding unit
106 Information transmission unit
200 Display device (sink device)
201 HDMI input terminal
202 HDMI reception unit
203 Control unit
204 Signal processing unit
205 Display unit
300 Video signal processing device (converter device)
301 HDMI input terminal
302-1 to 302-N HDMI output terminal
303 HDMI reception unit
304-1 to 304-4 HDMI transmission unit
305 Control unit
306 Signal processing unit
307 Selection unit
400, 500 HDMI cable
602 Data transmission unit of source device (HDMI transmission unit)
621 HDMI transmitter
622 IIC master block
702 Data reception unit of sink device (HDMI reception
unit)
721 HDMI receiver
722 Memory unit
731 EDID ROM
732 SCDC register unit
800 HDMI cable

1. A video signal processing device comprising:
an information reception unit that receives capability information from each of a plurality of display devices;
an information transmission unit that generates multi-stream information on a basis of the capability information of the plurality of display devices and information of a type of multi-display display implemented by the plurality of display devices, and transmits the multi-stream information to a video signal output device;
a multi-stream reception unit that receives, from the video signal output device, a multi-stream including video streams for the plurality of display devices, respectively, generated on a basis of the multi-stream information; and
a video stream transmission unit that extracts the plurality of video streams from the multi-stream and transmits each of the plurality of video streams to a corresponding display device out of the plurality of display devices.

2. The video signal processing device according to claim 1, wherein
the type of multi-display display includes at least any one of optional arrangement, preset arrangement, planar arrangement, circumferential surface arrangement, or spherical surface arrangement.

3. The video signal processing device according to claim 1, wherein
the multi-stream information includes information of the number of the plurality of display devices and information of the type of multi-display display.

4. The video signal processing device according to claim 3, wherein
the multi-stream information includes stream identification information and arrangement position information corresponding to each of the plurality of display devices.

5. The video signal processing device according to claim 3, wherein
in a case where the type of multi-display display is planar arrangement, the multi-stream information includes information of a pixel position on an upper left end of a screen corresponding to each of the plurality of display devices.

6. The video signal processing device according to claim 3, wherein
in a case where the type of multi-display display is circumferential surface arrangement, the multi-stream information includes information of a screen center angle and information of an occupied viewing angle corresponding to each of the plurality of display devices.

7. The video signal processing device according to claim 3, wherein
in a case where the type of multi-display display is spherical surface arrangement, the multi-stream information includes information of a screen horizontal direction center angle, information of a screen vertical direction center angle, and information of an occupied viewing angle in a horizontal direction or a vertical direction corresponding to each of the plurality of display devices.

8. The video signal processing device according to claim 3, wherein
the multi-stream information includes information of a video format corresponding to each of the plurality of display devices.

9. The video signal processing device according to claim 1, wherein
each video stream included in the multi-stream includes stream identification information indicating the display device to which the video stream corresponds.

10. A video signal processing method comprising steps of:
receiving capability information from each of a plurality of display devices;
generating multi-stream information on a basis of the capability information of the plurality of display devices and information of a type of multi-display display implemented by the plurality of display devices, and transmitting the multi-stream information to a video signal output device;
receiving, from the video signal output device, a multi-stream including video streams for the plurality of display devices, respectively, generated on a basis of the multi-stream information; and
extracting the plurality of video streams from the multi-stream and transmitting each of the plurality of video streams to a corresponding display device out of the plurality of display devices.

11. A video signal output device comprising:
an information reception unit that receives, from a video signal processing device to which a plurality of display devices is connected, multi-stream information generated on a basis of capability information of the plurality of display devices and information of a type of multi-display display implemented by the plurality of display devices; and
a multi-stream transmission unit that generates a multi-stream including video streams for the plurality of display devices, respectively, on a basis of the multi-stream information, and transmits the multi-stream to the video signal processing device.

12. A video signal output device comprising:
an information reception unit that receives capability information from each of a plurality of display devices; and
a video stream transmission unit that generates video streams for the plurality of display devices, respectively, on a basis of the capability information of the plurality of display devices and information of a type of multi-display display implemented by the plurality of display devices, and transmits each of the video streams to a corresponding display device out of the plurality of display devices.

13. A multi-display system comprising:
a video signal output device and a plurality of display devices connected to each other via a video signal processing device, wherein
the video signal processing device:
receives capability information from each of the plurality of display devices;
generates multi-stream information on a basis of the capability information of the plurality of display devices and information of a type of multi-display display implemented by the plurality of display devices, and transmits the multi-stream information to the video signal output device;
receives, from the video signal output device, a multi-stream including video streams for the plurality of display devices, respectively, generated on a basis of the multi-stream information; and
extracts the plurality of video streams from the multi-stream and transmits each of the plurality of video streams to a corresponding display device out of the plurality of display devices.
